(19) United States
(12) Patent Application Publication
(10) Pub. No.: US 2006/0092503 A1
(43) Pub. Date: May 4, 2006

(54) Portable microscope with detachable portion

(75) Inventor: Mary Rebecca Saunders, Baltimore, MD (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: UNIVERSITY OF MARYLAND, BALTIMORE, Baltimore, MD (US)

(21) Appl. No.: 11/259,723

(22) Filed: Oct. 26, 2005

Related U.S. Application Data
(60) Provisional application No. 60/622,133, filed on Oct. 26, 2004.

(51) Int. Cl. G02B 21/00

(52) U.S. Cl. 359/368; 359/382

(57) ABSTRACT

A portable microscope comprising a detachable portion comprising an eye piece, an objective lens, a light source, and an optical filter, and a base portion comprising a stage for placement of a specimen to be examined, wherein the detachable portion and the base portion are adapted to be connected to each other and disconnected from each other by a user of the microscope.

### CROSS-REFERENCE TO RELATED PATENT APPLICATIONS

This patent application claims the benefit of U.S. Provisional Patent Application No. 60/622,133, filed Oct. 26, 2004.

### FIELD OF THE INVENTION

This invention relates to portable microscopes, and, more particularly, to portable fluorescence microscopes that can be broken down into smaller components.

### BACKGROUND OF THE INVENTION

Fluorescent light is used by investigators to analyze the properties of many substances, including cells. In particular, for example, a cell of interest can be injected with a fluorescent dye and examined under a fluorescence microscope, which bathes the cell in fluorescent light, whereupon certain structures in or on the cell “fluoresce” or react by emitting visible light that can be observed by an investigator. This allows the investigator, for example, to track the flow of certain molecular structures through the cell.

Conventional fluorescence microscopes tend to be large and expensive, however. Therefore, despite the tremendous utility of fluorescence microscopes, the availability of these microscopes to those who might benefit from their use is generally limited. Even when they are available, these microscopes often have to be shared among multiple investigators. Therefore, a need remains for fluorescence microscopes that are portable and less expensive.

### BRIEF SUMMARY OF THE INVENTION

The present invention provides a portable microscope comprising a detachable portion comprising an eye piece, an objective lens, a light source, and an optical filter, and a base portion comprising a stage for placement of a specimen to be examined, wherein the detachable portion and the base portion are adapted to be connected to each other and disconnected from each other by a user of the microscope.

The present invention also provides a portable microscope comprising a detachable portion comprising a generally tubular first housing having a top end and a bottom end, an eye piece disposed at the top end, an objective lens disposed at the bottom end, a light source attached to the generally tubular first housing, and an optical filter disposed between the objective lens and the light unit, and a base portion comprising a stage for placement of a specimen to be examined, wherein the detachable portion and the base portion are adapted to be connected to each other and disconnected from each other by a user of the microscope.

### BRIEF DESCRIPTION OF THE DRAWINGS

FIG. 1 is a diagram depicting a microscope configured according to an embodiment of the invention.

FIG. 2 is a diagram depicting the detachable portion of the microscope of FIG. 1.

FIG. 3 is a diagram depicting the base portion, as well as the mounting member and the optical filter of the detachable portion of the microscope of FIG. 1.

FIG. 4 is a diagram depicting an alternate embodiment of the detachable portion of FIG. 1.

FIG. 5 is a diagram depicting the light unit and light path tube of the detachable portion of FIG. 4.

FIG. 6 is a diagram depicting a microscope configured according to an alternate embodiment of the invention.

FIG. 7 is a diagram depicting a microscope configured according to an alternate embodiment of the invention.

### DETAILED DESCRIPTION OF THE INVENTION

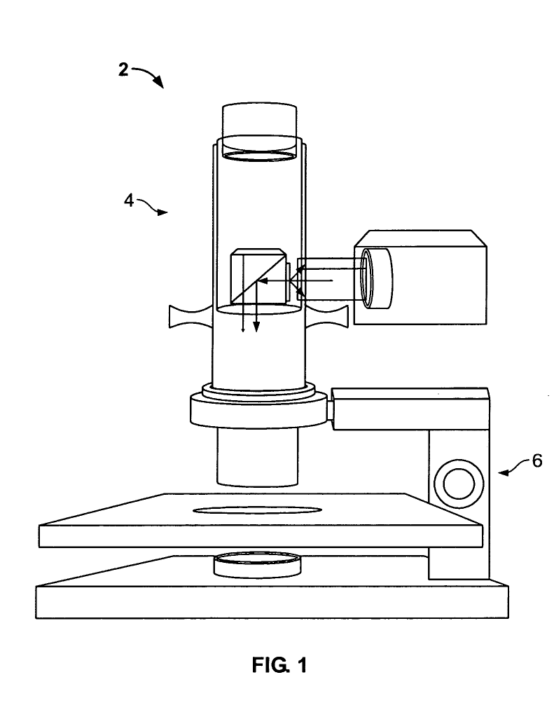

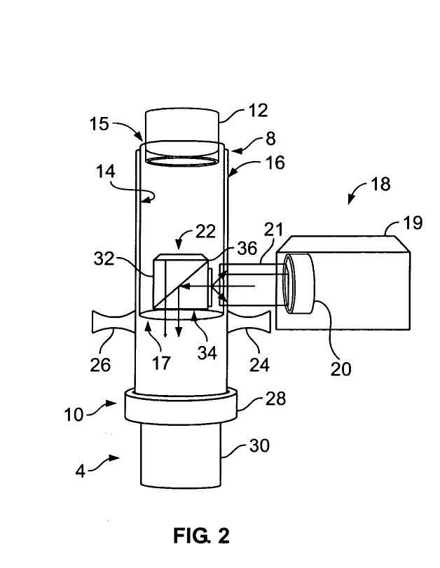

The present invention is generally directed to a portable microscope with a detachable portion. Referring to FIG. 1, an embodiment of the microscope is shown. The microscope, generally labeled 2, includes a detachable portion 4 and a base portion 6. The detachable portion 4, shown in FIG. 2, includes a generally tubular first housing 16 having an upper end 8 and a lower end 10. Coupled to the lower end 10 on the outer surface of the first housing 16 is a mounting member or ring 28. A generally tubular second housing 30 is coupled to the inner surface of the first housing 16 at the lower end 10 of the first housing 16. Secured within the second housing 30 is an objective lens of the microscope 2. A first hand grip 24 and a second hand grip 26 are attached to the outer surface of the first housing 16.

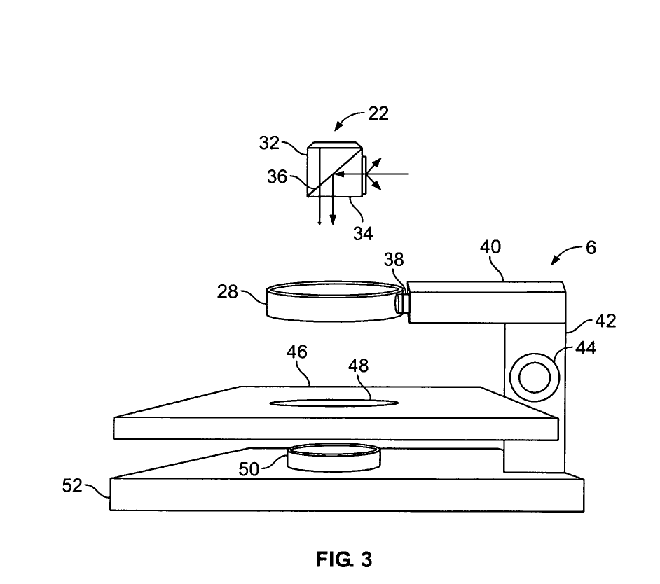

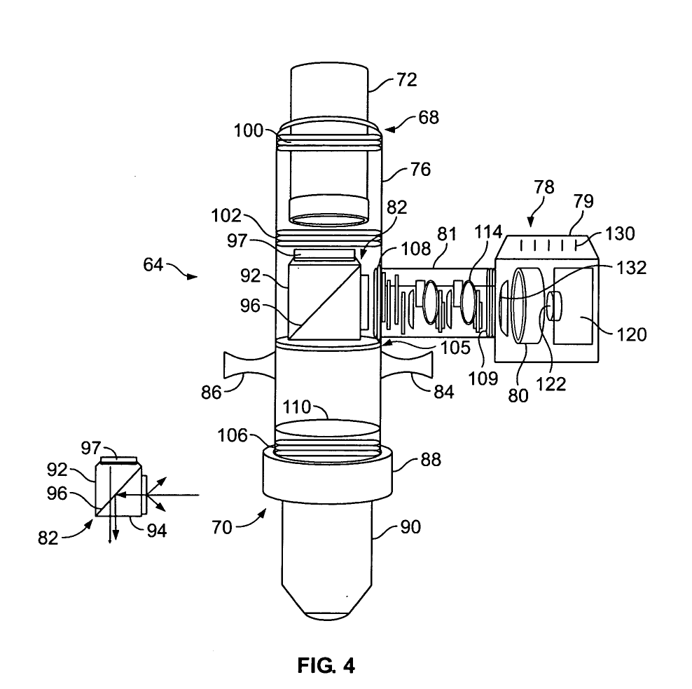

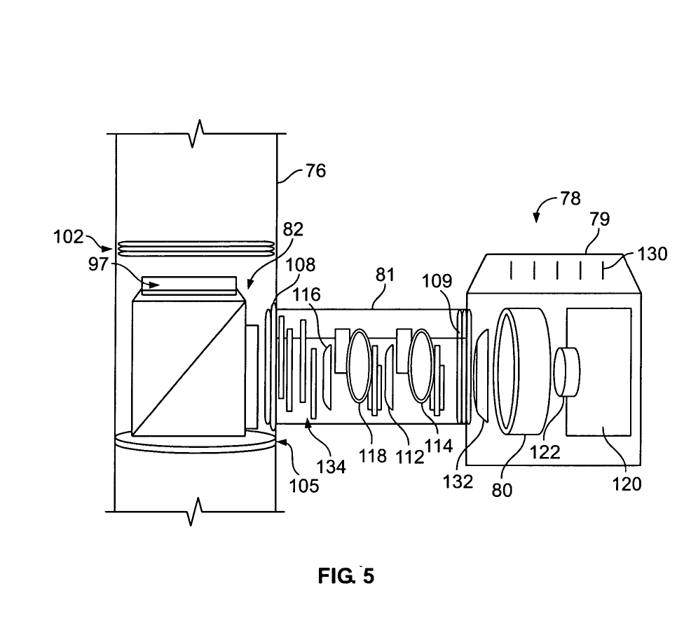

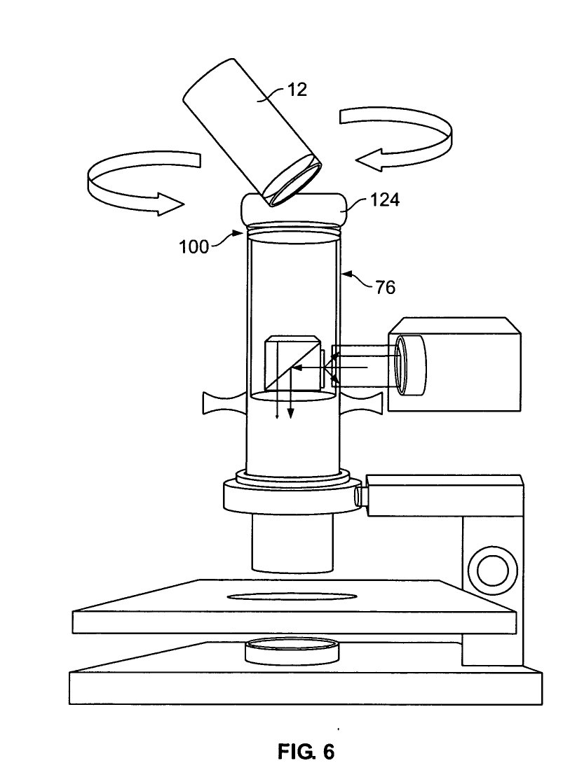

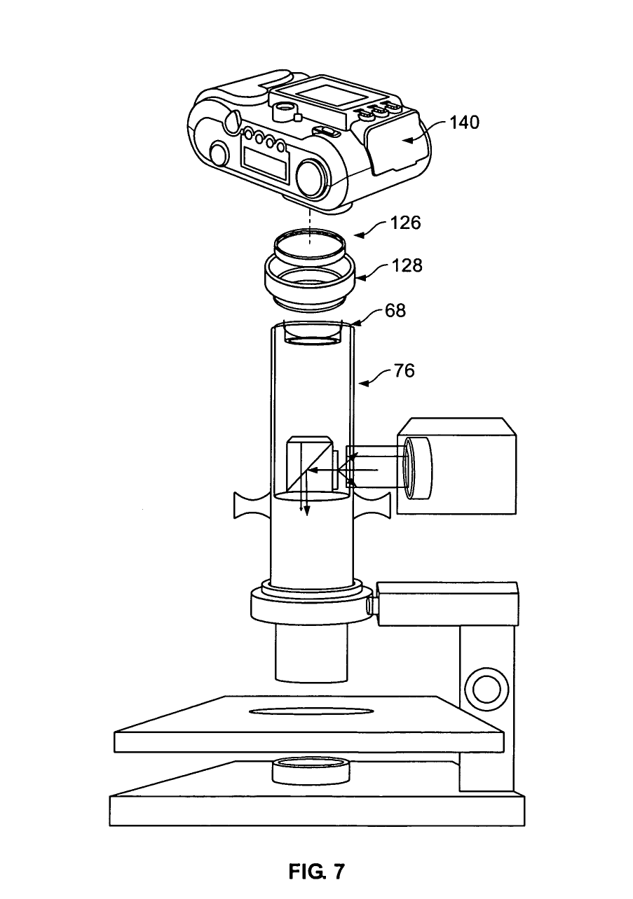

The detachable portion 4 also includes a generally tubular third housing 14 disposed within and coupled to the inner surface of the first housing 16. The third housing 14 has an upper end 15 and a lower end 17. A filter cube 22 having a dichroic mirror or excitation filter is disposed within and/or coupled to (e.g., is situated or positioned atop a mounting shelf (illustrated in FIGS. 4 and 5)) within the third housing 14 near its lower end 17. As shown in FIGS. 2 and 3, the filter cube 22 has a first facet 32, a second facet 34, a third facet 36, and an emission or barrier filter. The detachable portion 4 illustrated in FIG. 2 also comprises an eye piece 12 having a direct, in-line configuration that is disposed partially within, and coupled to the upper end 15 of the third housing 14, e.g., such that the lower end of the eye piece 12 is in proximity to the upper end of the filter cube 22. This configuration enables direct in-line examination of a specimen. Alternatively, as illustrated in FIG. 6, the eye piece 12 can be angled in configuration. Moreover, as discussed below with respect to FIG. 6, the eye piece 12 can be rotatable, thereby allowing a user of the microscope to rotate, swivel, or reposition the eye piece 12 to a desired orientation prior to or during use of the microscope. Moreover, as discussed below with respect to FIG. 7, the eye piece 12 can be fitted with an adapter to allow it to be attached to a still image or video camera, thereby allowing photos or videos of the specimen to be taken. The detachable portion, in this regard, can comprise two or more adaptors for attachment of two or more eye pieces to the detachable portion. In particular, for example, the detachable portion can comprise an adaptor for attachment of a still image or video camera, in addition to an adaptor for attachment of a direct, in-line eye piece or an angular (e.g., angular swiveling) eye piece, so that, for example, a user can position a specimen and focus on it, and then capture an image of the specimen on film, without having to first substitute the eye piece for a camera. In one embodiment, for example, a single threaded, Y-shaped adaptor that is connected or attached to the upper end 8 of the detachable portion 4 and which comprises a first portal for attachment of a direct, in-line or angular eye piece, and a second portal for attachment of a still image or video camera.

The detachable portion 4 also comprises a light unit 18. As illustrated in FIG. 2, the light unit can comprise a housing 19, a light source 20 (such as a fluorescent light source, e.g., an ultraviolet LED), and a battery or power supply (not illustrated in FIG. 2) that provides power to the light source 20. The housing 19 of the light unit 18, in this embodiment, can have a generally circular opening that receives one end of a light path tube 21, wherein the other end of the light path tube 21 is coupled to the first housing 16 and the second housing 14. The light unit 19 can be coupled to the light path tube 21 in a variety of ways so as to make it easily removable. For example, the light unit 19 can be threadingly engaged, lock-fit, attached with a pin, attached with mounting brackets, seat-fit, or snap-fit to the lower end of the light path tube 21. In another embodiment, the housing 18 of the light unit 19 has a removable lid, and a removable light source 20. Thus, instead of changing the entire light unit 19, the investigator could just open the lid and change the light source 20. In another embodiment of the invention, the light unit 19 is removable from the detachable portion 4 and replaceable with a light source of any wavelength. A user of the microscope, for example, can change, substitute, or replace the light unit with a light source of any other wavelength (e.g., fluorescent wavelength), thereby allowing for a full range of fluorescence assays, e.g., utilizing any suitable fluorescent probe or dye. In particular, for example, the light unit can be a source of any suitable wavelength, such as, for example, a wavelength of 380 nm, 395 nm, 470 nm, 518 nm, 590 nm, or 640 nm. It is understood by those of skill in the art, in this regard, that the user must utilize a light source of a wavelength that corresponds to the particular optical filter and the particular fluorescent probe or dye being utilized. It is even suitable, for example, for an investigator to have a variety of light sources (for example, each with its own housing), so that when the investigator wishes to change the light source, he or she simply removes the light unit 19 and replaces it with another light unit that contains a light source of the desired wavelength.

The detachable portion 4 also comprises an optical filter. The optical filter, as illustrated in FIGS. 1-6, can be in the form of a filter cube 22, which comprises a dichroic mirror or excitation filter, an emission or barrier filter, a first facet 32, a second facet 34, and a third facet 36. The filter cube 22 can be threadingly engaged, lock-fit, attached with a pin, attached with mounting brackets, seat-fit or snap-fit into place, such as, for example, atop a mounting shelf (as illustrated in FIGS. 4 and 5). Alternatively, the optical filter can be in the form of a filter wheel comprising a plurality of filter regions for different wavelengths disposed thereon, which a user can selectively utilize, e.g., through manipulation of the orientation of the filter wheel, e.g., that is disposed between the light source 20 and the opening of the light unit housing 19. Moreover, the optical filter can be in the form of a slider component, e.g., in the form of rectangular inserts comprising a plurality (e.g., a row) of filter regions for different wavelengths disposed thereon, which a user can selectively utilize, e.g., through manipulation of the placement or orientation of the slider component. In this regard, the optical filter can be removable from the detachable portion 4 and replaceable with an optical filter for any wavelength. Moreover, accessibility to the optical filter can be increased, such that a user can more easily remove or replace the optical filter through utilization of an eye piece 12 that is removable, as discussed above. In this manner, for example, a user of the microscope can first remove the eye piece 12 of the microscope, and then change, substitute, or replace the optical filter with an optical filter for any other wavelength (e.g., fluorescent wavelength), thereby allowing for a full range of fluorescent assays, e.g., utilizing any fluorescent probes or dyes.

FIG. 3 illustrates the base portion 6 of the microscope 2, in operational association with the mounting member or ring 28 and the filter cube 22 of the detachable portion 4 of FIG. 2. The base portion 6 includes a stand base 52, an upright support member 42 attached to the stand base 52, and a support arm 40. The support arm 40 is attached to the upright support member 42 at one end. On the other end of the support arm 40 is an attachment member 38. The attachment member 38 provides a surface on which the mounting member or ring 28 of the detachable portion 4 of the microscope 2 can be attached. The attachment member 38 and the mounting member 28, in this regard, can comprise any suitable corresponding or coordinating structures, which enable connecting and disconnecting of the attachment member 38 and the mounting member 28 to each other by a user of the microscope 2 in such a manner that the user can construct and deconstruct the microscope 2 repeatedly with relative ease (i.e., with minimal effort or complexity, such as, for example, through the manipulation of a single release element or through the disengaging of a single threaded element) and with a minimal amount of wear and tear. In particular, for example, the mounting ring 28 can comprise a hole or depression that is configured so as to allow the mounting ring 28 to engage securely the attachment member 38.

According to an embodiment of the invention, the microscope is portable, meaning that the detachable portion and/or the base portion of the microscope are capable of being manually carried or moved by a user without assistance by other users or by mechanical means. The detachable portion and/or the base portion of the microscope can even be pocket-sized or can fit within a protective sleeve or case that can be carried with ease by a user. In particular, for example, the detachable portion can be as small as about 5-15 (e.g., 7.5) inches tall, with a tubular diameter of about 1-3 (e.g., 1.75) inches, and a weight of approximately 20 ounces or less (e.g., 12 ounces). Moreover, the light unit and light path tube can be approximately 2-10 (e.g., 6) inches in length The base portion, for example, be approximately 3-12 (e.g., 5.5) inches in height, approximately 3-12 (e.g., 4.75) inches in width, and approximately 3-20 (e.g., 7.5) inches in length, with a weight of approximately 20 ounces or less (e.g., 16 ounces). The base portion 4, in this regard, can have a small footprint (e.g., 6×6 inches), which allows the microscope 2 to be mounted on a bench or in a hood. The portability of the microscope facilitates use by multiple users and/or for multiple purposes (such as, for example, field use, teaching laboratories and the like) without restriction to location. In particular, for example, an investigator who wishes to examine multiple specimens at multiple different examining stations can remove or disconnect the detachable portion 4 of the microscope 2 from the base portion 6, place the detachable portion into a protective sleeve, case, and/or his/her pocket, for example, and move to a destination examination station. Once at the destination, the investigator can take the detachable portion out of the protective sleeve, case, and/or his/her pocket, for example, attach the detachable portion to a different base portion, turn on the light unit of the detachable portion, and view a specimen at the destination examination station. This is very convenient for an investigator who needs to have a fluorescence microscope readily available, and, for example, only needs to know whether a specimen fluoresces or not. This is of particular advantage to tissue culture applications, since the researcher would not have to remove cultures from the hood, which reduces the potential for airborne contamination of the cultures. This embodiment also saves time, in that it eliminates the need to transport the cultures to a standard, large-size fluorescence microscope which, itself, requires significant time to start up.

As further illustrated in FIG. 3, the upright support member 42 of the microscope 2 also comprises a stage control 44, which includes a knob, a shaft that is attached to the knob and that extends through a hole in the upright support member, and a gear that is attached to the shaft and is located on the other side of the upright support member 42 as the knob. A stage 46 is slidably attached to the upright support member 42, and has a set of teeth that engage the gear of the stage control 44, so that when a user rotates the knob of the stage control 44, the gear causes the stage 46 to move up or down along the upright support member 42. The stage 46 has a generally circular opening 48 for placement of a specimen. A condenser 50 is attached to the stand base 52 underneath the opening 48 of the stage 46. The condenser 50 is optional, and allows for bright light to be transmitted in view of the specimen.

In an embodiment of the invention, the second housing 30 is removable and replaceable, thereby allowing an investigator to change easily objective lenses and thereby permit a wide range of fluorescence assays. Thus, the investigator can have a variety of objective lenses (for example, wherein each lens has its own housing), so that when the investigator wishes to change the objective lens, he or she simply removes the second housing 30 and replaces it with another housing that contains the desired objective lens. Accordingly, the lower end 10 of the first housing 16 is configured to fit standard objective housings. The second housing 30 can be coupled to the first housing 16 in a variety of ways so as to make it easily removable. For example, the second housing 30 can be engaged by threads, lock-fit, attached with a pin, attached with mounting brackets, seat-fit, or snap-fit to the lower end 10 of the first housing 16.

The base portion 6 and the detachable portion 4 (e.g., the housings of the detachable portion) can be constructed of any suitable material. In particular, for example, the base portion 6 and the detachable portion 4 can be made of polycarbonate material, resulting in a construction that is inexpensive, lightweight, durable, and heat-resistant.

Referring to FIG. 4, an alternative embodiment of the detachable portion is shown. The detachable portion, generally labeled 64, includes a generally tubular first housing 76 having an upper end 68 and a lower end 70. Coupled to the lower end 70 on the outer surface of the first housing 76 is a mounting ring 88. A generally tubular second housing 90 is threadingly engaged to the inner surface of the first housing 76 at a threaded portion 106 at the lower end 70 of the first housing 76. Secured within the second housing 90 is an objective lens of the microscope (not illustrated in the figure). The second housing 90 and its constituent parts, in this regard, can be referred to as the “objective.” A tube lens 110 can be disposed near the lower end 70 of the first housing 76, in order to increase the amount of light that enters the second housing 90. A first hand grip 84 and a second hand grip 86 are attached to the outer surface of the first housing 76.

The detachable portion 64 also comprises any suitable optical filter, as discussed above. In the embodiment illustrated in FIG. 4, the filter cube 82 is disposed within and/or coupled to the first housing 76 near its lower end 70, and is situated or positioned atop a mounting shelf 105. As shown in the lower left corner of FIG. 4, and as discussed above, the filter cube 82 comprises a dichroic mirror or excitation filter, an emission or barrier filter, a first facet 92, a second facet 94, and a third facet 96. Arrows are included in the figure to depict the path of light passing through the filter cube.

The detachable portion 64 also comprises an eye piece 72 having a direct, in-line configuration that is disposed partially within, and coupled to the upper end 68 of the first housing 76. In particular, for example, the eye piece 72 can be threadingly engaged to a threaded portion 100 or 102 of the first housing 76. Moreover, as discussed below with respect to FIG. 6, the eye piece 72 can be angular in configuration and can be rotatable, thereby allowing a user of the microscope to rotate, swivel, or reposition the eye piece 72 to a desired orientation prior to or during use of the microscope. Moreover, as discussed below with respect to FIG. 7, the eye piece 72 can be fitted with an adapter to allow it to be attached to a still image or video camera, thereby allowing photos or videos of the specimen to be taken. In one embodiment, as discussed above, for example, a single threaded, Y-shaped adaptor that is connected or attached to the upper end 8 of the detachable portion 4 and which comprises a first portal for attachment of a direct, in-line or angular eye piece, and a second portal for attachment of a still image or video camera.

The detachable portion 64 can also include a light unit 78 having a housing 79, a light source 80 (such as a fluorescent light source, e.g., an ultraviolet LED), and a battery or power supply 120 that provides power to the light source 80. The housing 79 of the light unit 78 has a generally circular opening that receives one end of a light path tube 81, to which the housing 79 can be threadingly engaged at threaded portion 109, wherein the other end of the light path tube 81 is threadingly engaged to the first housing 76 at a threaded portion 108. The light unit 78, light path tube 81 and filter cube 82, along with their constituent components, are also referred to collectively as a “vertical fluorescence illuminator.” Moreover, as illustrated in FIGS. 4-5, the light unit 78 also includes a ventilator 130, a mirror 122 disposed between the power supply or battery 120 and the light source 80, and a collector lens 132 disposed between the light source 80 and the light path tube 81. The light path tube 81 has openings 134 that can accommodate an optional filter slider component, as discussed above. The filter slider is used in conjunction with the filter cube 82 to detect multiple fluorophores. Disposed within the light path tube 81 are a field diaphragm 116, a field lens 118, a condenser aperture 112, and a condenser lens 114.

Referring to FIG. 6, and as discussed above with respect to FIGS. 2 and 4, the eye piece 72 can be angular in configuration and rotatable. In particular, for example, the eye piece 72 can be operably-connected to a rotator or swivel element 124 (e.g., angular swivel element) which is threadingly-engaged to the upper end 68 of the first housing 76 at threaded portion 100. The rotatable nature of the eye piece 72 can enable a user of the microscope to rotate, swivel, or reposition the eye piece 72 to any desired position or orientation prior to, or during, use of the microscope. Directional arrows are included in the figure to indicate the rotatable nature of the eye piece 72 in this embodiment of the present invention.

Referring to FIG. 7, and as discussed above with respect to FIGS. 2 and 4, the upper end 68 of the detachable portion 64 can be operably-connected to an adapter that connects to a still image or video camera 140, thereby allowing photos or videos of the specimen to be taken. In this regard, for example, the adaptor can comprise a series of ring attachments comprising, for example, a filter 126 and a lens shade 128. Moreover, as discussed above with respect to FIGS. 2 and 4, the detachable portion can comprise two or more adaptors for attachment of two or more eye pieces to the detachable portion. In particular, for example, the detachable portion can comprise an adaptor for attachment of a still image or video camera, in addition to an adaptor for attachment of a direct, in-line eye piece or an angular (e.g., angular swiveling) eye piece, so that, for example, a user can position a specimen and focus on it, and then capture an image of the specimen on film, without having to first substitute the eye piece for a camera. In one embodiment, for example, a single threaded, Y-shaped adaptor that is connected or attached to the upper end 68 of the detachable portion 64 and which comprises a first portal for attachment of a direct, in-line or angular eye piece, and a second portal for attachment of a still image or video camera.

It can thus be seen that a new and useful portable fluorescence microscope with a detachable portion has been provided. Although embodiments of the present invention have been described in detail above, those skilled in the art will readily appreciate that many modifications are possible in the exemplary embodiments without materially departing from the novel teachings and advantages of this invention. For example, the portable fluorescence microscope described herein could be implemented as an inverted microscope. The microscope could also be provided with phase contrast capability. Accordingly, all such modifications are intended to be included within the scope of this invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A portable microscope, comprising:
a detachable portion comprising an eye piece, an objective lens, a light source, and an optical filter; and
a base portion comprising a stage for placement of a specimen to be examined;
wherein the detachable portion and the base portion are adapted to be connected to each other and disconnected from each other by a user of the microscope.

2. The microscope of claim 1, wherein the detachable portion further comprises a mounting member, wherein the base portion further comprises an attachment member, and wherein the mounting member and the attachment member collectively form a connection between the detachable portion and the base portion that is engagable and disengageable by a user such that a connection between the detachable portion and the base portion exists or does not exist, respectively.

3. The microscope of claim 1, wherein the eye piece is removable from the detachable portion.

4. The microscope of claim 1, wherein the eye piece is rotatable.

5. The microscope of claim 1, wherein the eye piece is connectable to a still image or video camera.

6. The microscope of claim 1, wherein the detachable portion further comprises an adaptor comprising a first portal for attaching the eye piece and a second portal for attaching a still image or video camera.

7. The microscope of claim 1, wherein the objective lens is removable from the detachable portion.

8. The microscope of claim 1, wherein the light source is an ultraviolet light source.

9. The microscope of claim 1, wherein the light source is removable from the detachable portion.

10. The microscope of claim 1, wherein the optical filter is selected from the group consisting of a filter cube, a filter wheel, and a slider component.

11. A portable microscope comprising:
a detachable portion comprising a generally tubular first housing having a top end and a bottom end, an eye piece disposed at the top end, an objective lens disposed at the bottom end, a light unit attached to the generally tubular first housing for providing a light source to the microscope, and an optical filter disposed between the objective lens and the light unit; and
a base portion comprising a stage for placement of a specimen to be examined, wherein the detachable portion and the base portion are adapted to be connected to each other and disconnected from each other by a user of the microscope.

12. The microscope of claim 11, wherein the eye piece is removable from the detachable portion.

13. The microscope of claim 11, wherein the eye piece is rotatable.

14. The microscope of claim 11, wherein the eye piece is connectable to a still image or video camera.

15. The microscope of claim 11, wherein the objective lens is situated within a generally tubular second housing that is coupled to inner surface of the generally tubular first housing at the bottom end.

16. The microscope of claim 11, wherein the objective lens is removable from the detachable portion.

17. The microscope of claim 11, wherein the light source is ultraviolet light.

18. The microscope of claim 11, wherein the optical filter is selected from the group consisting of a filter cube, a filter wheel, and a slider component.

19. The microscope of claim 18, wherein the optical filter is situated within a generally tubular third housing that is coupled to the inner surface of the generally tubular first housing.

20. The microscope of claim 18, wherein the optical filter is removable from the detachable portion.
